(19) United States
(12) Patent Application Publication
(10) Pub. No.: US 2025/0180284 A1
(43) Pub. Date: Jun. 5, 2025

(54) METHOD AND DEVICE FOR CONDITIONING BIOGAS IN COMPACT FORM

(71) Applicant: ENGIE, Courbevoie (FR)

(72) Inventors: Gaspard BOUTEAU, Courbevoie (FR); Laurent BENOIT, Courbevoie (FR)

(21) Appl. No.: 18/839,427

(22) PCT Filed: Mar. 23, 2023
(86) PCT No.: PCT/EP2023/057527

§ 371 Date: Aug. 18, 2024

(30) Foreign Application Priority Data
Mar. 28, 2022 (FR) FR2202774

(51) Int. Cl. F25J 1/00; B01D 53/02; B01D 53/26; C10L 3/10

(52) U.S. Cl. CPC F25J 1/0027; B01D 53/02; B01D 53/265; C10L 3/106; B01D 2253/102; B01D 2257/304; B01D 2257/708; B01D 2257/80; B01D 2258/05

(57) ABSTRACT

The invention relates to a method (100) for conditioning biogas in compact form, the method comprising:
a step (105) of receiving a biogas stream comprising at least methane;
a step (110) of measuring a flowrate of biogas at the inlet;
a step (115) of injecting a carbon dioxide stream into the biogas stream as a function of the measured flowrate, configured so that the fraction of carbon dioxide represents between 40% and 56% of the molar mass of the mixture comprising at least carbon dioxide and methane;
a step (120) of compressing the mixture to a pressure higher than or equal to 80 bara;
a step (125) of cooling the compressed mixture to a temperature of between −50° C. and 5° C. to bring the mixture to a liquid or supercritical state; and
a step (130) of releasing the mixture.

### TECHNICAL FIELD OF THE INVENTION

The present invention relates to a method for conditioning biogas in compact form and a device for conditioning biogas in compact form. It applies, in particular, to the field of the treatment and conditioning of biogas for the purpose of upgrading this biogas.

### STATE OF THE ART

In the field of biogas (or biomethane), one problem lies in the collection of biogas produced on a small scale and in locations far from the gas transport network.

To be able to collect this biogas, the logistical and local treatment costs must be minimised. These costs are driven by the current collection and treatment methods.

To resolve this technical problem, four types of strategy are currently being implemented:
compressing the biogas to transport it at high pressure (typically at a pressure greater than 200 bara)—the problem is that, due to the high carbon dioxide content of the biogas (typically greater than 35% of the molar mass), the carbon dioxide can condense during compression, and therefore it requires a costly special compressor able to evacuate the carbon dioxide that condenses during treatment;
cooling and liquefying the biogas to condense it: here again the problem arises from the high carbon dioxide content of the biogas—the risk is that a portion of the carbon dioxide will crystallise well before the methane-enriched mixture is liquid, thus blocking the process through the progressive clogging of the exchangers;
at least partially removing carbon dioxide from the biogas and then condensing the biogas: this is the BioCNG (CNG being the acronym for “Compressed Natural Gas”) or BioLNG (LNG being the acronym for “Liquefied Natural Gas”) technology—the processes are costly and therefore hardly profitable at the low levels of biogas production that are typically associated with farms (less than 150 Nm³/h of biogas); and
modifying the composition of the biogas by adding a third component making it possible to prevent the crystallisation of the carbon dioxide and therefore to condense the biogas in liquid form—the third component, typically a hydrocarbon of type C₃ to C₇, always requires liquefaction at low temperatures (at least −50° C. and more frequently below −80° C.) so as to limit the quantity of the third component and not overload the logistics chain, in addition to difficulties linked to the regeneration of this third component, which often requires a specific separation with a distillation column.

As a result, the current methods present technical risks for the compressors, linked to the risks of carbon dioxide condensation, the risks of heat exchanger clogging, or costs not allowing implementation for small-scale biogas sources.

Thus there is currently no solution allowing biogas conditioning that makes possible the small-scale exploitation of the biogas produced.

### Subject of the Invention

The present invention aims to remedy all or part of these drawbacks.

To this end, according to a first aspect, the present invention envisages a method for conditioning biogas in compact form, the method comprising:
a step of receiving a biogas stream comprising at least methane;
a step of measuring a flowrate of the received biogas;
a step of injecting a carbon dioxide stream into the biogas stream as a function of the measured flowrate, configured so that the fraction of carbon dioxide represents between 40% and 56% of the molar mass of the mixture comprising at least carbon dioxide and methane;
a step of compressing the mixture to a pressure higher than or equal to 80 bara;
a step of cooling the compressed mixture to a temperature of between −50° C. and 5° C. to bring the mixture to a liquid or supercritical state; and
a step of releasing the mixture coming from the cooling step.

Thanks to these provisions:
the condensation of carbon dioxide during compression is avoided;
the crystallisation of carbon dioxide is also avoided;
the pressure utilised makes it possible to limit the costs and the energy used to utilise the device the method that is the subject of the invention;
utilising a temperature that is low but higher than −50° C. makes it possible to reduce the cooling costs and utilise non cryogenic equipment;
injecting carbon dioxide into the stream enables condensation at relatively warm temperatures and makes a simplified regeneration possible because it is combined with a final biogas purification phase.

In some embodiments, the cooling step comprises a step of exchanging heat with the at least partially liquid carbon dioxide, the carbon dioxide output from the heat exchange step being utilised during the injection step.

In some embodiments, the liquid carbon dioxide utilised during the heat exchange step has a pressure higher than or equal to 6 bara.

Thanks to these provisions, the cold of the vaporised liquid carbon dioxide makes it possible to end the condensation of the mixture of biogas and carbon dioxide, making it possible to only utilise a cooling cycle to 0° C.

In some embodiments, the method that is the subject of the present invention comprises a step of separating water contained in the biogas stream coming from the receiving step and/or contained in the mixture coming from the injection step.

These embodiments limit the risks of equipment damage.

In some embodiments, the method that is the subject of the present invention comprises a step of drying the biogas upstream from a step of the method utilising a temperature below 0° C.

These embodiments limit the risks of equipment damage.

In some embodiments, the method that is the subject of the present invention comprises an additional step of removing water from the biogas upstream from a step of the method utilising a temperature below 0° C.

These embodiments limit the risks of equipment damage.

In some embodiments, the method that is the subject of the present invention comprises a step of separating hydrogen sulphide contained in the biogas stream coming from the receiving step and/or contained in the mixture coming from the injection step.

These embodiments limit the risks of equipment damage.

In some embodiments, the method that is the subject of the present invention comprises a step of separating volatile organic compounds contained in the stream coming from the receiving step and/or contained in the mixture coming from the injection step.

These embodiments limit the risks of equipment damage.

In some embodiments, the method that is the subject of the present invention comprises, downstream from the compression step, a step of pre-cooling the mixture to a temperature lower than or equal to 2° C.

In some embodiments, the step of compressing the mixture is configured to compress the mixture to a pressure between 80 bara and 120 bara.

These embodiments enable, in particular, the formation of a biogas in compact form under optimum operating conditions.

According to a second aspect, the present invention envisages a device for conditioning biogas in compact form, the device comprising:
a means for receiving a biogas stream comprising at least methane;
a means for measuring a flowrate of biogas at the inlet;
a means for injecting a carbon dioxide stream into the biogas stream as a function of the measured flowrate, configured so that the fraction of carbon dioxide represents between 40% and 56% of the molar mass of the mixture comprising at least carbon dioxide and methane;
a means for compressing the mixture to a pressure higher than or equal to 80 bara;
a means for cooling the compressed mixture to a temperature of between −50° C. and 5° C. to bring the mixture to a liquid or supercritical state; and
a means for releasing the mixture coming from the cooling step.

The advantages of the device that is the subject of the present invention are similar to the advantages of the method that is the subject of the present invention.

### BRIEF DESCRIPTION OF THE FIGURES

Other advantages, aims and particular features of the invention will become apparent from the non-limiting description that follows of at least one particular embodiment of the method and device that are the subjects of the present invention, with reference to drawings included in an appendix, wherein:

FIG. 1 represents, schematically and in the form of a logical diagram, a first particular series of steps of the method that is the subject of the present invention;

FIG. 2 represents schematically a first particular embodiment of the device that is the subject of the present invention;

FIG. 3 represents, schematically and in the form of a logical diagram, a second particular series of steps of the method that is the subject of the present invention;

FIG. 4 represents, schematically, a second particular embodiment of the device that is the subject of the present invention;

FIG. 5 represents, schematically, a third particular embodiment of the device that is the subject of this invention;

FIG. 6 represents, schematically and in the form of a logical diagram, a second particular series of steps of the method that is the subject of the present invention;

FIG. 7 represents, schematically and in the form of a logical diagram, a third particular embodiment of the method that is the subject of the present invention; and

FIG. 8 represents, schematically, a fourth particular embodiment of the device that is the subject of the present invention.

### DESCRIPTION OF THE EMBODIMENTS

The present description is given in a non-limiting way, in which each characteristic of an embodiment can be combined with any other characteristic of any other embodiment in an advantageous way.

As can be seen from reading the present description, different inventive concepts can be implemented by one or more methods or devices described below, several examples of which are given here. The actions or steps performed in the framework of realising the method or device can be ordered in any appropriate way. As a consequence, it is possible to construct embodiments in which the actions or 25 steps are performed in a different order from the one shown, which can include executing some acts simultaneously, even if they are presented as sequential acts in the embodiments shown.

The expression “and/or”, as it is used in the present document and in the claims, must be understood as meaning “one or other, or both” of the elements thus connected, i.e. elements that are present conjunctively in some cases and disjunctively in other cases. The multiple elements listed with “and/or” must be interpreted in the same way, i.e. “one or more” of the elements thus connected. Other elements can possibly be present, other than the elements specifically identified by the clause “and/or”, whether or not they are linked to these specifically identified elements. Therefore, as a non-limiting example, a reference to “A and/or B”, when it is used in conjunction with open-ended language such as “comprising”, can refer, in one embodiment, to A only (possibly including elements other than B); in another embodiment, to B only (possibly including elements other than A); in yet another embodiment, to A and B (possibly including other elements); etc.

As used in the present description and in the claims, “or” must be understood inclusively.

As used here in the present description and in the claims, the expression “at least one”, in reference to a list of one or more elements, must be understood as meaning at least one element chosen from among one or more elements in the list of elements, but not necessarily including at least one of each element specifically listed in the list of elements and not excluding any combination of elements in the list of elements. This definition also allows the optional presence of elements other than the elements specifically identified in the list of elements to which the expression “at least one” refers, whether or not they are linked to these specifically identified elements. Therefore, as a non-limiting example, “at least one of A and B” (or, equivalently, “at least one of A or B” or, equivalently, “at least one of A and/or B”), can refer, in one embodiment, to at least one, possibly including more than one, A, with no B present (and possibly including elements other than B); in another embodiment, to at least one, possibly including more than one, B, with no A present (and possibly including elements other than A); in yet another embodiment, to at least one, possibly including more than one, A and at least one, possibly including more than one, B (and possibly including other elements); etc.

In the claims, and also in the description below, all the transitive expressions such as “comprising”, “including”, “bearing”, “having”, “containing”, “involving”, “made of”, “formed of” and others, must be understood as being open, i.e. meaning including, but not limited to. Only the transitive expressions “consisting of” and “consisting essentially of” must be understood as closed or semi-closed expressions, respectively. In the present description, the term “biogas stream comprising at least methane” refers to a stream which can comprise in addition to methane at least one of the following elements:
water;
hydrogen sulphide;
volatile organic compounds; and/or
carbon dioxide.

It is now noted that the figures are not to scale.

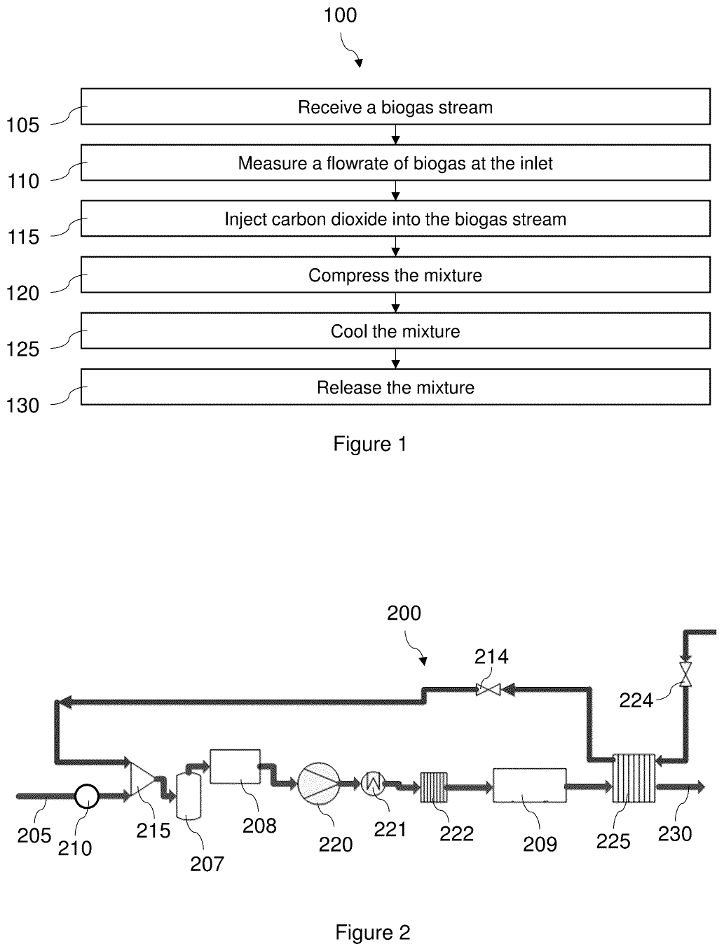

FIG. 1 shows a particular series of steps of the method 100 that is the subject of the present invention. This method 100 for conditioning biogas in compact form comprises:
a step 105 of receiving a biogas stream comprising at least methane;
a step 110 of measuring a flowrate of biogas the received biogas;
a step 115 of injecting a carbon dioxide stream into the biogas stream as a function of the measured flowrate, configured so that the fraction of carbon dioxide represents between 40% and 56% of the molar mass of the mixture comprising at least carbon dioxide and methane;
a step 120 of compressing the mixture to a pressure higher than or equal to 80 bara;
a step 125 of cooling the compressed mixture to a temperature of between-50° C. and 5° C. to bring the mixture to a liquid or supercritical state; and
a step 130 of releasing the mixture coming from the cooling step.

The receiving step 105 is performed, for example, by a receiving means 205 as shown in FIG. 2. Such a receiving means 205 is, for example, a pipe configured to convey a biogas stream comprising at least methane. This pipe can be connected to a tank (not shown), or connected directly or indirectly to a port compatible with the pipe. Such a port is, for example, configured to be connected to a mobile tank, such as a tanker truck.

The exact nature of the receiving means 205 depends on the use case of the method 100 that is the subject of the present invention and its actual utilisation is not important provided that the biogas comprising at least methane can be routed towards a means 215 for injecting carbon dioxide.

The measurement step 110 is performed, for example, by utilising a means 210 for measuring a flowrate of biogas as shown in FIG. 2. Such a measurement means 210 is, for example, a flowmeter or any other sensor suitable for measuring a flowrate in a pipe.

In some variants, the measurement step 110 is not present in the method 100, the device 200 performing the method 100 being suitable for a stable nominal flowrate of biogas, the injection of carbon dioxide gas being adapted for this predefined nominal flowrate to achieve a predefined proportion in the mixture resulting from the injection.

The injection step 115 is performed, for example, by an injection means 215 as shown in FIG. 2. Such an injection means 215 is, for example, an injection pipe injecting carbon dioxide into the biogas stream. In some variants, the injection means 215 is a mixer with two inlets, one for the biogas stream and the other for the carbon dioxide, and one outlet for the mixture thus formed.

For example, before the injection step, the mixture stream has the following characteristics:
a volumetric flowrate close to 108 Nm³/h;
a mass flowrate close to 153 kg/h, constituted for 119 kg/h of carbon dioxide and 34 kg/h of methane;
a pressure close to 1.05 bara;
a temperature close to 30° C.; and
a molar ratio close to 44% methane and 56% carbon dioxide.

In some variants, the carbon dioxide injected into the biogas stream is injected in liquid form. In some variants, the carbon dioxide injected into the biogas stream has a lower temperature than that of the biogas. In some variants, the device 200 performing the method 100 that is the subject of the present invention comprises a biogas temperature sensor (not shown), the flowrate of carbon dioxide injected into the biogas being controlled by the temperature measured.

In some variants, the carbon dioxide utilised during the injection step 115 is initially stored in a tank (not shown), in liquid and/or gaseous form.

In some variants, the method 100 that is the subject of the present invention comprises a carbon dioxide expansion step (not shown) before the injection step 215. This expansion step is performed, for example, by an expansion means 214 as shown in FIG. 2. This expansion means 214 is, for example, an expansion valve.

For example, before this expansion step, the carbon dioxide stream has the following characteristics:
a pressure close to 6 bara; and
a temperature close to 0° C.

For example, on output from this expansion step, the carbon dioxide stream has the following characteristics:
a pressure close to 1.05 bara; and
a temperature close to −7.2° C.

The compression step 120 is performed, for example, by a compression means 220 as shown in FIG. 2. Such a compression means 220 is, for example, a turbine compressor or any other type of compressor suitable for the specific operating conditions of the mixture of biogas and carbon dioxide.

In some embodiments, the compression step 120 is performed for compression to a value between 80 bara and 120 bara.

The cooling step 125 is performed, for example, by a cooling means 225 as shown in FIG. 2. Such a cooling means 225 is, for example, any type of heat exchanger suitable for the specific operating conditions of the mixture of biogas and carbon dioxide. For example, the heat exchanger is a tube or finned heat exchanger.

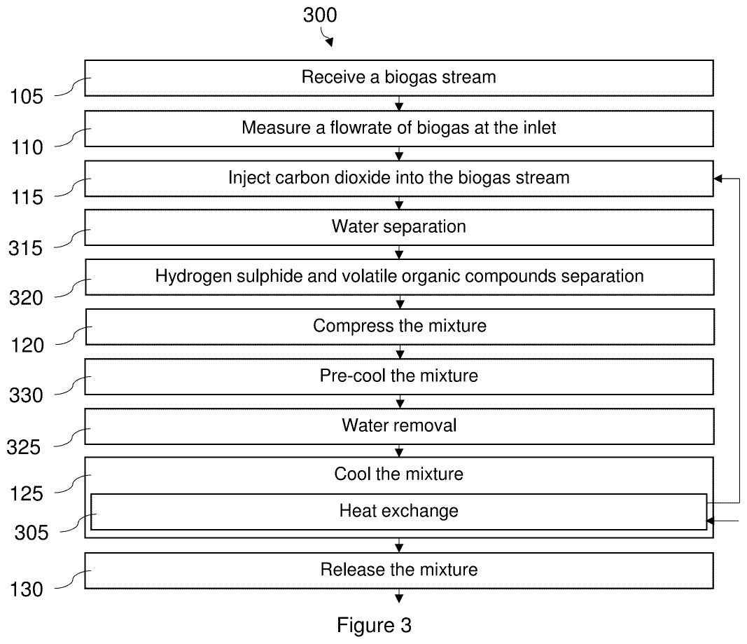

In some particular embodiments, such as that shown in FIG. 3, the cooling step 125 comprises a step 305 of exchanging heat with the at least partially liquid carbon dioxide, the carbon dioxide output from the heat exchange step 305 being utilised during the injection step 115.

This heat exchange step 305 is performed, for example, by the heat exchange means 225 utilised during the heat exchange step 125 in which the carbon dioxide acts as cold fluid.

In some variants, the method 300 that is the subject of the present invention comprises a carbon dioxide expansion step (not shown) before the heat exchange step 305. This expansion step is performed, for example, by an expansion means 224 as shown in FIG. 2. This expansion means 224 is, for example, an expansion valve.

For example, before this expansion step, the carbon dioxide stream has the following characteristics:
a mass flowrate close to 80 kg/h;
a pressure close to 19.5 bara; and
a temperature close to −20° C.

For example, on output from this expansion step, the carbon dioxide stream has the following characteristics:
a pressure close to 6 bara;
a temperature close to −52.5° C.; and
a vapour fraction close to 0.19.

In some embodiments, the carbon dioxide utilised during the heat exchange step 305 has a pressure higher than or equal to 6 bara.

The release step 130 is performed, for example, by a release means 230 as shown in FIG. 2. Such a release means 230 is, for example, a pipe allowing the cooled mixture to be transferred during the cooling step 225.

For example, on output from this release step, the mixture stream has the following characteristics:
a pressure close to 88 bara;
a temperature close to −17° C.; and
a vapour fraction close to 0.

In some variants, the gas mixture cooled during the cooling step 225 is stored in a tank (not shown), in liquid and/or gaseous form.

In some embodiments of the method 300 that is the subject of the present invention, such as that shown in FIG. 3, the method 300 comprises a step 315 of separating water contained in the biogas stream coming from the receiving step 105 and/or contained in the mixture coming from the injection step 115.

The separation step 315 can be performed, for example, by a separation means 207, as shown in FIG. 2. Such a separation means 207 is, for example, a water separator by condensation.

The separation step 315 can be performed, for example, by a separation means 209, as shown in FIG. 2. Such a separation means 209 is, for example, a water separator by condensation. This separation means 209 is also referred to as “means for drying and polishing” the mixture.

For example, this drying and polishing means is configured to lower the dew point to 2° C./88 bara.

In some embodiments of the method 300 that is the subject of the present invention, such as that shown in FIG. 3, the method 300 comprises a step 320 of separating hydrogen sulphide contained in the biogas stream coming from the receiving step 105 and/or contained in the mixture coming from the injection step 115.

The hydrogen sulphide separation step 320 can be performed, for example, by a separation means 208, as shown in FIG. 2. Such a separation means 208 is, for example, an activated carbon filter positioned downstream from the mixer 215.

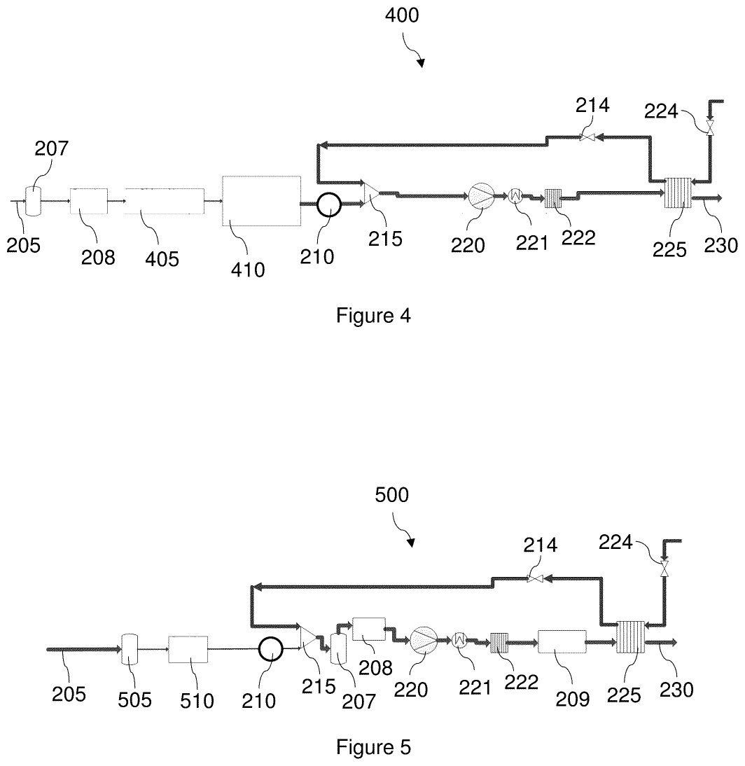

The hydrogen sulphide separation step 320 can be performed, for example, by a separation means 208, as shown in FIG. 4. Such a separation means 208 is, for example, an activated carbon filter positioned upstream from the mixer 215.

In some embodiments of the method 300 that is the subject of the present invention, such as that shown in FIG. 3, the method 300 comprises a step 320 of separating volatile organic compounds contained in the stream coming from the receiving step 105 and/or contained in the mixture coming from the injection step 115. This step 320 of separating volatile organic compounds can be performed at the same time as the step 320 of separating hydrogen sulphide.

The hydrogen sulphide removal step 320 is performed, for example, by a separation means 209, as shown in FIG. 2. Such a separation means 209 is, for example, an activated carbon filter.

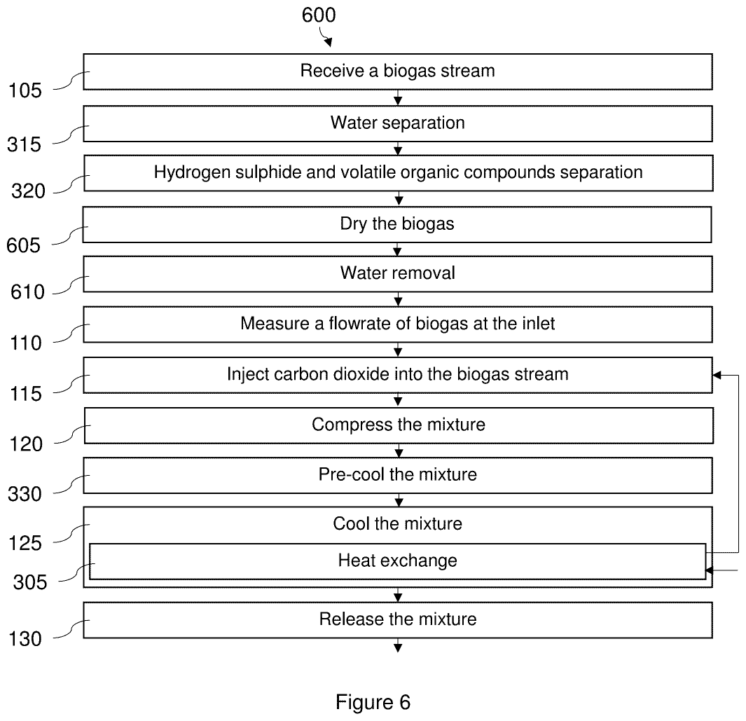

In some embodiments of the method 600 that is the subject of the present invention, such as that shown in FIG. 6, the method 600 comprises a step 605 of drying the biogas upstream from a step of the method utilising a temperature below 0° C. This step utilising a temperature below 0° C. corresponds, for example, to a heat exchange step 305 or a pre-cooling step 330 according to the implementation specifications of the method that is the subject of the present invention.

The drying step 605 is performed, for example, by a drying means 405, as shown in FIG. 4. Such a drying means 405 is, for example, a heat exchanger combined with a phase separator container.

In some embodiments of the method 600 that is the subject of the present invention, such as that shown in FIG. 6, the method 600 comprises an additional step 610 of removing water from the biogas upstream from a step of the method utilising a temperature below 0° C. This additional removal can be performed, for example, by means of an adsorption system to lower the dew point temperature of the biogas to a value below −50° C.

The additional water removal step 610 is performed, for example, by a means 410 for removing water, as shown in FIG. 4. Such a water-removal means 410 is, for example, molecular sieves.

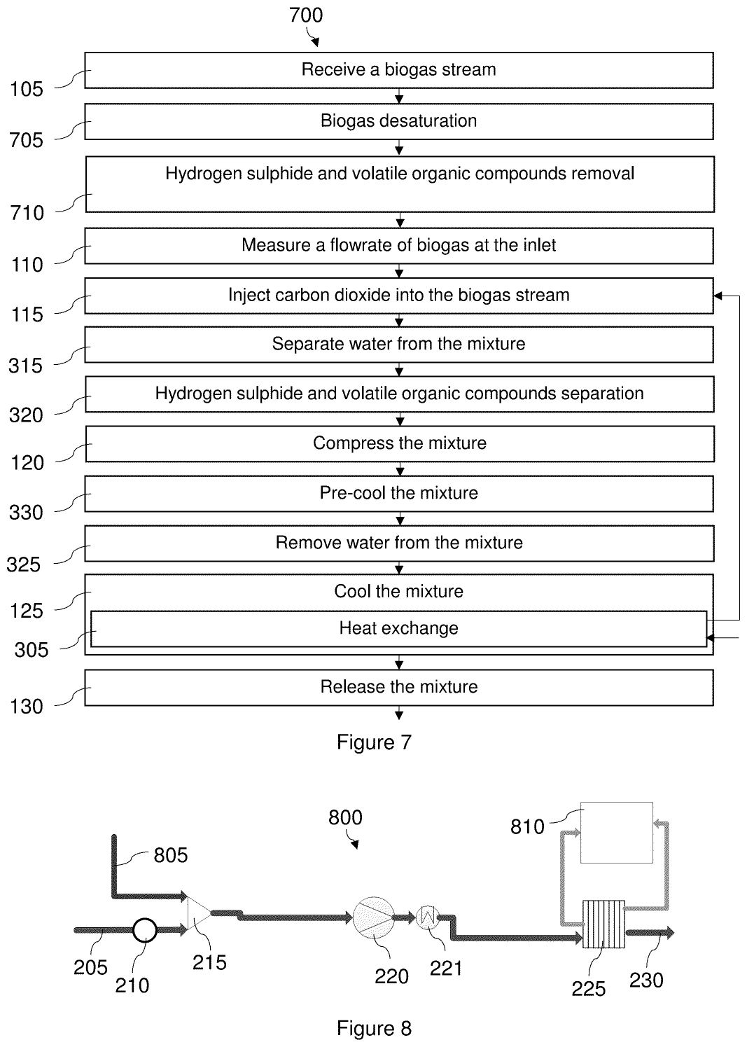

In some embodiments of the method 700 that is the subject of the present invention, such as that shown in FIG. 7, the method 700 comprises a step 705 of desaturating the biogas coming from the receiving step 105.

The desaturation step 705 is performed, for example, by a desaturation means 505, as shown in FIG. 5. Such a desaturation means 505 is, for example, a heat exchanger combined with a phase separator container.

In some embodiments of the method 700 that is the subject of the present invention, such as that shown in FIG. 7, the method 700 comprises a step 710 of removing hydrogen sulphide and/or volatile organic compounds contained in the biogas coming from the desaturation step 705.

The biogas purification step 710 is performed, for example, by a biogas purification means 510, as shown in FIG. 5. Such a biogas purification means 510 is, for example, an activated carbon filter.

For example, on output from the purification step 710, the biogas stream has the following characteristics:
a volumetric flowrate close to 80 Nm³/h;
a mass flowrate close to 97 kg/h, constituted for 63 kg/h of carbon dioxide and 34 kg/h of methane;
a pressure close to 1.05 bara;
a temperature close to 30° C.; and
a molar ratio close to 60% methane and 40% carbon dioxide.

In some particular embodiments, the method 300 that is the subject of the present invention comprises a step 330 of pre-cooling the mixture to a temperature lower than or equal to 2° C.

This pre-cooling step 330 is performed, for example, by a pre-cooling means 222, as shown in FIG. 2. This pre-cooling means 222 is, for example, a heat exchanger.

In some variants, the pre-cooling step 330 is performed in two pre-cooling sub-steps. Such a variant is shown in FIG. 2 and comprises an initial pre-cooling means 221 followed by a pre-cooling means 222.

For example, on output from this initial pre-cooling step, the mixture stream has the following characteristics:
a pressure greater than 80 bara; and
a temperature close to 30° C.

For example, on output from this pre-cooling step, the mixture stream has the following characteristics:
a pressure greater than 80 bara; and
a temperature close to 2° C.; and
a vapour fraction close to 1.

FIG. 3 shows a particular series of steps of the method 300 that is the subject of the present invention. This method 300 for conditioning biogas in compact form comprises, in addition to the steps described with regard to FIG. 1, at least one of the steps mentioned below.

As can be understood from reading the present description, FIG. 2 shows, schematically, an embodiment of the device 200 that is the subject of the present invention. This device 200 for conditioning biogas in compact form comprises:
a means 205 for receiving a biogas stream comprising at least methane;
a means 210 for measuring a flowrate of biogas at the inlet;
a means 215 for injecting a carbon dioxide stream into the biogas stream as a function of the measured flowrate, configured so that the fraction of carbon dioxide represents between 40% and 56% of the molar mass of the mixture comprising at least carbon dioxide and methane;
a means 220 for compressing the mixture to a pressure higher than or equal to 80 bara;
a means 225 for cooling the compressed mixture to a temperature between-50° C. and 5° C. to bring the mixture to a liquid or supercritical state; and
a means 230 for releasing the mixture coming from the cooling step.

Implementation examples of means characteristic of devices 200 and 400, subjects of the present invention, are described with reference to FIGS. 1 and 3 corresponding to the methods that are the subjects of the present invention.

FIG. 8 shows, schematically, a particular embodiment of the device 800 for conditioning biogas in compact form, which comprises:
a means 205 for receiving a biogas stream comprising at least methane;
a means 210 for measuring a flowrate of biogas at the inlet;
a means 215 for injecting a carbon dioxide stream into the biogas stream as a function of the measured flowrate, configured so that the fraction of carbon dioxide represents between 40% and 56% of the molar mass of the mixture comprising at least carbon dioxide and methane;
a means 220 for compressing the mixture to a pressure higher than or equal to 80 bara;
a means 225 for cooling the compressed mixture to a temperature between-50° C. and 5° C. to bring the mixture to a liquid or supercritical state; and
a means 230 for releasing the mixture coming from the cooling step.

This particular embodiment of the device 800 also utilises, in particular:
a means 805 for receiving carbon dioxide, liquid or gas, configured to interact with the injection means 215 in order to form the mixture to be cooled; and
a cycle 810 of cooling to a temperature between −50° C. and 5° C., configured to act as cold fluid in the cooling means 225.

In these embodiments, the cooling of the mixture and the supply of carbon dioxide are separate.

As can be understood, the method and device that are the subjects of the present invention enable the condensation of the biogas, i.e. firstly with a final mixture density greater than 380 kg/m³ and a specific density of methane (the most reusable compound) in the mixture greater than 90 kg/m³, at temperatures higher than or equal to −50° C. (therefore, a level that is not cryogenic) and even preferably greater than or equal to −20° C., and at pressures lower than or equal to 120 bara and preferably lower than or equal to 100 bara.

1. Method (100, 300, 600, 700) for conditioning biogas in compact form, characterised in that it comprises:
a step (105) of receiving a biogas stream comprising at least methane;
a step (110) of measuring a flowrate of the received biogas;
a step (115) of injecting a carbon dioxide stream into the biogas stream as a function of the measured flowrate, configured so that the fraction of carbon dioxide represents between 40% and 56% of the molar mass of the mixture comprising at least carbon dioxide and methane;
a step (120) of compressing the mixture to a pressure higher than or equal to 80 bara;
a step (125) of cooling the compressed mixture to a temperature of between −50° C. and 5° C. to bring the mixture to a liquid or supercritical state; and
a step (130) of releasing the mixture coming from the cooling step.

2. Method (300, 600, 700) according to claim 1, wherein the cooling step (125) comprises a step (305) of exchanging heat with the at least partially liquid carbon dioxide, the carbon dioxide output from the heat exchange step being utilised during the injection step (115).

3. Method (300, 600, 700) according to claim 2, wherein the carbon dioxide utilised during the heat exchange step (305) has a pressure higher than or equal to 6 bara.

4. Method (300, 600, 700) according to claim 1, which comprises a step (315) of separating water contained in the biogas stream coming from the receiving step (105) and/or contained in the mixture coming from the injection step (115).

5. Method (600) according to claim 1, which comprises a step (605) of drying the biogas upstream from a step of the method utilising a temperature below 0° C.

6. Method (600) according to claim 5, which comprises an additional step (610) of removing water from the biogas upstream from a step of the method utilising a temperature below 0° C.

7. Method (300, 600, 700) according to claim 1, which comprises a step (320) of separating hydrogen sulphide contained in the biogas stream coming from the receiving step (105) and/or contained in the mixture coming from the injection step (115).

8. Method (300, 600, 700) according to claim 1, which comprises a step (325) of separating volatile organic compounds contained in the stream coming from the receiving step (105) and/or contained in the mixture coming from the injection step (115).

9. Method (300, 600, 700) according to claim 1, which comprises, downstream from the compression step (120) a step (330) of pre-cooling the mixture to a temperature lower than or equal to 2° C.

10. Method (100, 300, 600, 700) according to claim 1, wherein the step (120) of compressing the mixture is configured to compress the mixture to a pressure between 80 bara and 120 bara.

11. Device (200, 400, 500, 800) for conditioning biogas in compact form, characterised in that it comprises:
a means (205) for receiving a biogas stream comprising at least methane;
a means (210) for measuring a flowrate of biogas at the inlet;
a means (215) for injecting a carbon dioxide stream into the biogas stream as a function of the measured flowrate, configured so that the fraction of carbon dioxide represents between 40% and 56% of the molar mass of the mixture comprising at least carbon dioxide and methane;
a means (220) for compressing the mixture to a pressure higher than or equal to 80 bara;
a means (225) for cooling the compressed mixture to a temperature of between −50° C. and 5° C. to bring the mixture to a liquid or supercritical state; and
a means (230) for releasing the mixture coming from the cooling step.
